(19) United States
(12) Patent Application Publication
(10) Pub. No.: US 2013/0117549 A1
(43) Pub. Date: May 9, 2013

(54) METHOD FOR EXECUTING MULTIPLE OPERATING SYSTEMS AND ELECTRONIC APPARATUS

(71) Applicant: Chih-Chung Lin, Taipei City (TW)

(72) Inventor: Chih-Chung Lin, Taipei City (TW)

(73) Assignee: INVENTEC CORPORATION, Taipei City (TW)

(21) Appl. No.: 13/316,033

(22) Filed: Dec. 9, 2011

(30) Foreign Application Priority Data
Nov. 4, 2011 (TW) 100140426

(51) Int. Cl. G06F 9/445; G06F 9/455

(52) U.S. Cl. 713/2

(57) ABSTRACT

A method for executing multiple operating systems (OSs) and an electronic apparatus are provided. Current hardware resources of the electronic apparatus are obtained after executing a boot process. The hardware resources are allocated to each of the OSs according to a resource allocation ratio, so as to load each of the OSs.

### CROSS-REFERENCE TO RELATED APPLICATION

This application claims the priority benefit of Taiwan application serial no. 100140426, filed on Nov. 4, 2011. The entirety of the above-mentioned patent application is hereby incorporated by reference herein and made a part of this specification.

### BACKGROUND OF THE INVENTION

1. Field of the Invention

The present invention generally relates to a mechanism for executing an operating system (OS), and more particularly, to a method for executing multiple OSs at the same time.

2. Description of Related Art

At present, hardware resources of a computer are controlled only by one OS in a period of time. If it is needed to install multiple OSs on a computer, a common method is to perform multiple master divisions to a magnetic disk of the computer, and then install different OSs respectively in divided partitions. Although such a method can achieve good performance, software supporting different OSs cannot be used synchronically. Therefore, Virtual Machine (VM) software is developed in order to execute OSs in a computer at the same time.

Based on the VM software, a user can execute any OS in the computer at the same time. Specifically, the VM software (for example, VMWare) is installed in a designated OS that is preferentially executed. Then, other OSs are installed on the VM software, so that other OSs can be executed by auxiliary application software.

However, such a measure cannot enable the OSs executed on the VM software to directly control and share computer resources, so that the execution efficiency of the OSs is far lower than those directly controlling the computer resources. That is to say, peripheral resources obtained by the OSs executed on the VM software are allocated and managed by the designated OS that is first executed after booting, and thus except for the designated OS, other OSs do not have independency as far as hardware is concerned. Accordingly, the performance thereof is greatly influenced and limited.

### SUMMARY OF THE INVENTION

The present invention is directed to a method for executing multiple OSs, so as to allow multiple OSs to be loaded and executed synchronically, thereby greatly improving the operation efficiency.

The present invention is further directed to an electronic apparatus, which allocates hardware resources to OSs in booting, so as to improve the efficiency and practicability of multiple OSs.

The present invention provides a method for executing multiple OSs, which is applicable to an electronic apparatus in which multiple OSs are installed. First, a boot process is executed. Then, existing hardware resources of the electronic apparatus are obtained. Then, the hardware resources are allocated to each of the OSs according to a resource allocation ratio. Each of the OSs is loaded according to the hardware resources allocated to each of the OSs.

In an embodiment of the present invention, in the step of allocating the hardware resources to each of the OSs according to the resource allocation ratio, multiple cores of a Central Processing Unit (CPU) are registered respectively to the OSs according to the resource allocation ratio. Moreover, an available space of a main memory is allocated to the OSs according to the resource allocation ratio, and the OSs are respectively loaded to the available space allocated thereto of the main memory.

In an embodiment of the present invention, before the step of loading each of the OSs according to the hardware resources allocated to each of the OSs, whether the electronic apparatus supports a Virtualization Technology (VT) may be determined first, so as to determine to simulate respective virtual environment of each of the OSs by using VT or VM software.

In an embodiment of the present invention, in the method of executing multiple OSs, a storage unit of the electronic apparatus may be divided into multiple partitions, to install the OSs respectively into the divided partitions. Moreover, respective boot information of each of the OSs is recorded in a firmware memory.

In an embodiment of the present invention, after loading each of the OSs, one of the OSs may be selected and displayed on a display unit.

On the other hand, the present invention provides an electronic apparatus, which includes a storage unit, a main memory, a firmware memory, and a CPU. The CPU is coupled respectively to the storage unit, the main memory, and the firmware memory. The storage unit is used for storing multiple OSs, the firmware memory stores system firmware and coexistence platform firmware. The CPU executes the system firmware to perform a boot process, executes the coexistence platform firmware, to obtain existing hardware resources of the electronic apparatus by using the coexistence platform firmware, allocates the hardware resources to each of the OSs according to a resource allocation ratio, and loads each of the OSs according to the resources allocated to each of the OSs.

In an embodiment of the present invention, the hardware resources are, for example, available resources of the CPU and an available space of the main memory. The CPU executes the coexistence platform firmware, to register multiple cores of the CPU respectively to the OSs by using the coexistence platform firmware according to the resource allocation ratio. The CPU also allocates the available space of the main memory to the OSs by executing the coexistence platform firmware, and loads the OSs respectively to the available space allocated thereto of the main memory.

In an embodiment of the present invention, the CPU executes the coexistence platform firmware, to determine whether the electronic apparatus supports VT by using the coexistence platform firmware, so as to determine to simulate respective virtual environment of the OSs by suing VT or VM software.

In an embodiment of the present invention, the storage unit includes multiple partitions, in which the OSs are respectively installed, and the firmware memory further records respective boot information of the OSs.

In an embodiment of the present invention, the electronic apparatus further includes a display unit, coupled to the CPU, and used for displaying one of the OSs.

Based on above, after the boot process is ended and before the OSs are loaded, the obtained hardware resources of the electronic apparatus are allocated to each of the OSs according to the resource allocation ratio. Then, the multiple OSs can be loaded at the same time and executed in the electronic apparatus synchronically. Accordingly, an efficient operation capability can be obtained, and a user can switch the OSs at will at any time, so that the user can execute software supporting different OSs at the same period of time, thereby greatly improving the operation efficiency.

In order to make the features and advantages of the present invention clearer, the present invention is described in detail below with reference to embodiments and accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus according to an embodiment of the present invention;

FIG. 2 is flow chart of a method for executing multiple OSs according to an embodiment of the present invention;

FIG. 3 is a schematic view of resource allocation of a CPU according to an embodiment of the present invention;

FIGS. 4A to 4C are schematic allocation views of a main memory according to an embodiment of the present invention;

FIG. 5 is a schematic view of system architecture according to an embodiment of the present invention; and

FIG. 6 is a flow chart of a method for executing multiple OSs according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In the prior art, functions of multiple OSs are all built on an OS that is preferentially executed, and thus the performance and efficiency thereof are greatly influenced and limited. Therefore, the present invention provides a method for executing multiple OSs and an electronic apparatus, which can execute multiple OSs synchronically and overcome the influence and limitation to performance and efficiency. In order to make the content of the present invention clearer, embodiments serving as examples based on which the present invention can be implemented are given below.

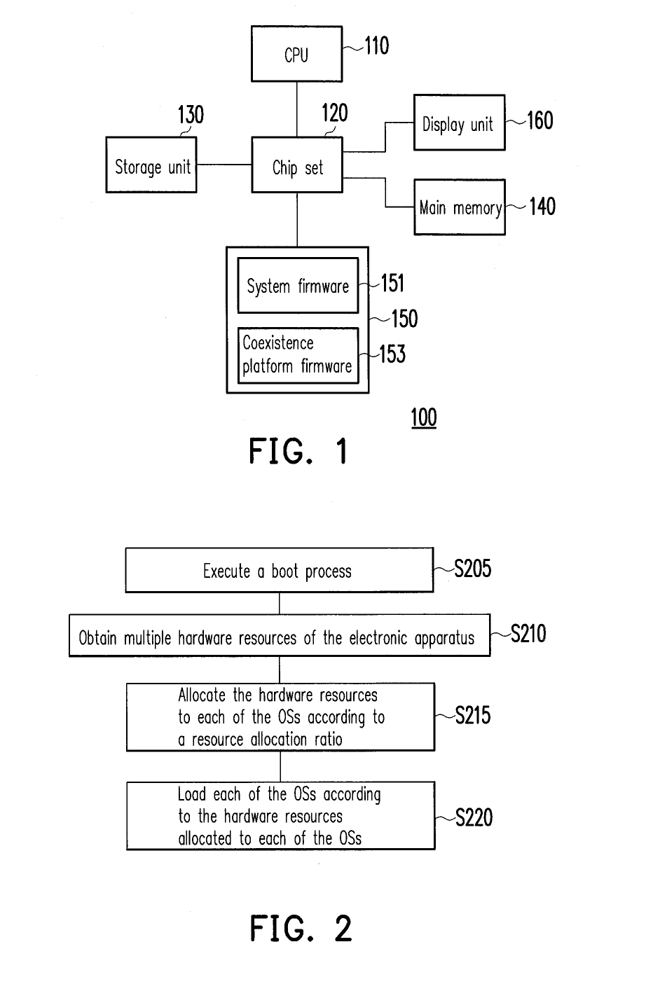

FIG. 1 is a block diagram of an electronic apparatus according to an embodiment of the present invention. Referring to FIG. 1, an electronic apparatus 100 includes a CPU 110, a chip set 120, a storage unit 130, a main memory 140, a firmware memory 150, and a display unit 160. The CPU 110 is coupled to the storage unit 130, the main memory 140, the firmware memory 150, and the display unit 160 through the chip set 120.

The CPU 110 is used for executing hardware and firmware and processing data in software in the electronic apparatus 100. The chip set 120 is a bridge of the CPU 110 for exchange information with the exterior. In this embodiment, the chip set 120 includes a Northbridge chip and a Southbridge chip. In other embodiment, the chip set 120 is, for example, a Southbridge chip, and the Northbridge chip can be integrated to the CPU 110. The storage unit 130 is, for example, a hard disk, and used for storing multiple OSs. For example, the storage unit 130 is divided into multiple partitions, to install the OSs respectively in the partitions.

Driving programs for all members and OSs in the electronic apparatus must be loaded onto the main memory 140 first, so that the CPU 110 can read them. Herein, the main memory 140 is, for example, a Random Access Memory (RAM). The firmware memory 150 is, for example, a flash memory, and used for storing various firmware. Herein, the firmware memory 150 stores system firmware 151 and coexistence platform firmware 153. The system firmware 151 is, for example, a Basic Input or Output System (BIOS), an Extensible Firmware Interface (EFI) BIOS, or a Unified Extensible Firmware Interface (UEFI) BIOS.

In this embodiment, the coexistence platform firmware 153 is designed in the firmware memory 150 storing the system firmware 151. At the time point after a boot process is ended and before the OSs are loaded, the CPU 110 executes the coexistence platform firmware 153, to load multiple OSs on the electronic apparatus 100 at the same time and execute the multiple OSs on the electronic apparatus 100 synchronically. For example, Microsoft Windows OS and Linux OS are executed in the electronic apparatus 100 at the same time. In initial setting, the coexistence platform firmware 153 divides a data buffer in the storage unit 130 in advance, to serve as a medium for transmission of the coexistence platform firmware. Furthermore, the firmware memory 150 also records boot information of each of the OSs. For example, when the storage unit 130 is divided into multiple partitions for installing multiple OSs, the boot information of the OSs is stored in the firmware memory 150.

The display unit 160 is used for displaying one of the OSs. At an initial stage of booting individual OS, the display unit 160 displays an OS that is preset to be used preferentially. If no OS is set by a user, a user interface of the coexistence platform firmware 153 is displayed, from which the user can select an OS to be displayed.

Furthermore, the OSs can be switched by using a hot key. For example, several built-in combined hot keys can allow the user to select and preset the OS (for example, “Ctrl+Alt+PgUp” or “Ctrl+Alt+PgDn”). When the combined hot keys are triggered by the user, the switching of the OSs is achieved by the coexistence platform firmware 153. In addition, a hardware switch button can be reserved in the hardware design stage, for example, a General Purpose I/O (GPIO) switch button. When the switch button is trigged by the user, the switching of the OSs is achieved through a system interruption program.

Step for executing multiple OSs are described with reference to the electronic apparatus 100. FIG. 2 is a flow chart of a method for executing multiple OSs according to an embodiment of the present invention. Referring to FIGS. 1 and 2, in Step S205, the CPU 110 executes the system firmware 151 to perform a boot process. For example, if the system firmware 151 is BIOS, the boot process includes Power On Self Test (POST) and initialization of peripheral devices.

Then, in Step S210, multiple hardware resources of the electronic apparatus are obtained. Next, in Step S215, the hardware resources are allocated to each of the OSs according to a resource allocation ratio. After the system firmware 151 execute the boot process, the coexistence platform firmware 153 obtains a dominant right to the system, and obtains available resources of the CPU 110, the main memory 140, the storage unit 130, and other peripheral devices, for resource allocation and management. For example, the coexistence platform firmware 153 allocates the hardware resources according to the number of the OSs to be installed and the resource allocation ratio.

In this embodiment, description is made with the available resource of CPU and the available space of the main memory as examples. The coexistence platform firmware 153 registers multiple cores of the CPU 110 respectively to each of the OSs according to the resource allocation ratio, and allocates the available space of the main memory 140 to each of the OSs. Herein, the CPU 110 has multiple cores; however, the present invention is not limited thereto, and in other embodiments, the CPU 110 may also have one core.

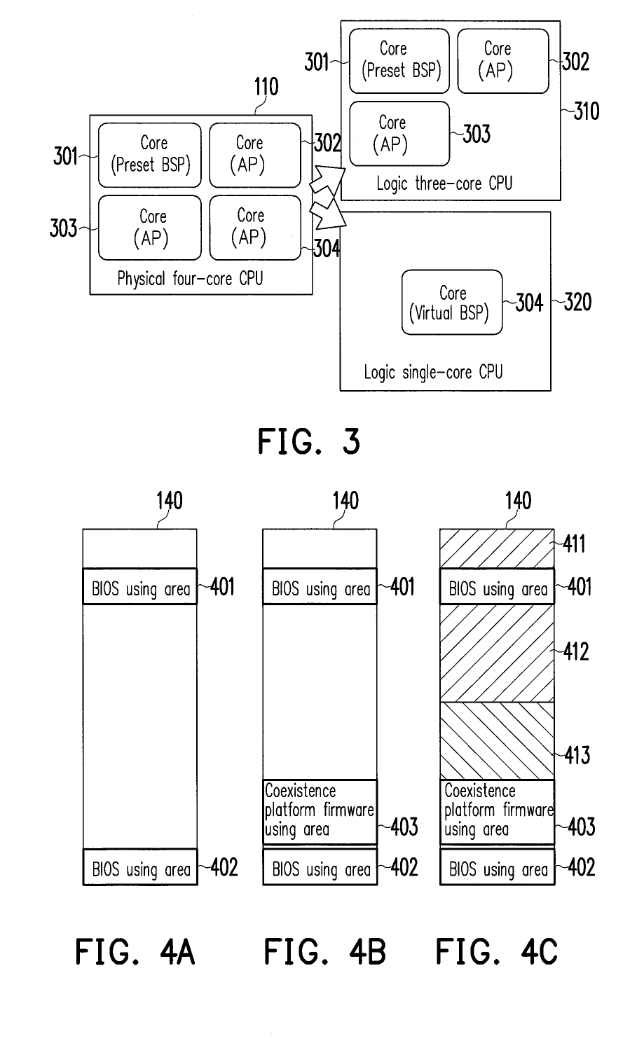

Resource allocation of the CPU 110 is described with an embodiment below. FIG. 3 is a schematic view of resource allocation of a CPU according to an embodiment of the present invention. Herein, the CPU 110 shown in FIG. 1 is taken as an example. Referring to FIG. 3, in this embodiment, it is assumed that the CPU 110 has four physical cores, that, a core 301, a core 302, a core 303, and a core 304. The core 301 is a Boot Strap Processor (BSP), and other cores 302, 303, and 304 are Application Processors (APs). For Intel x86 processor architecture system, after booting, a core controlling the whole system is designated as BSP, and other cores are used as APs.

It is assumed that two OSs are intended to be installed in the electronic apparatus 100, for example, Microsoft Windows OS and Linux OS. A user can set the resource allocation ratio in advance, and store the resource allocation ratio in the coexistence platform firmware 153; or the coexistence platform firmware 153 presets the resource allocation ratio. Herein, it is assumed that 75% of the hardware resources are allocated to Microsoft Windows OS, and 25% of the hardware resources are allocated to Linux OS. After the boot process is executed, the coexistence platform firmware 153 simulates the three cores 301, 302, and 303 of the CPU 110 as a logic three-core CPU 310 and registers the logical three-core CPU 310 to Microsoft Windows OS, and the remaining one core 304 is simulated as a logic single-core CPU 320 and registered to Linux OS.

In addition, generally after executing the boot process, the system firmware 151 collects the resources of the main memory 140, and reports available space of the main memory 140 to the OS after subtracting the portion sued by the system firmware execute 151. In this embodiment, the coexistence platform firmware 153 acquires the report in advance, to determine the hardware resources intended to be allocated to each of the OSs, and then reports the re-set available space of the main memory 140 to each of the OSs through the coexistence platform firmware 153.

For example, FIGS. 4A to 4C are schematic allocation views of a main memory according to an embodiment of the present invention. In this embodiment, the system firmware 151 is, for example, a BIOS, and it is assumed that the Microsoft Windows OS and the Linux OS are intended to be installed in the electronic apparatus 100.

In booting, the system firmware 151 is loaded to a BIOS using area 401, and a BIOS using area 402 (because the system firmware 151 may use different areas of the main memory 140), as shown in FIG. 4A. After executing the boot process, the coexistence platform firmware 153 is loaded to coexistence platform firmware using area 403 of the main memory 140, as shown in FIG. 4B. Then, the coexistence platform firmware 153 can know the current size (for example, 2 GB) of the available space of the main memory 140 according to the report of the system firmware 151, and know the actual allocation of the main memory 140 through a Global Descriptor Table (GDT). Then, the coexistence platform firmware 153 re-manages the GDT, and uses a protection-mode technology and a Local Descriptor Table (LDT) to separate the available space area of the main memory 140 required by the multiple OSs, as shown in FIG. 4C. As such, the coexistence platform firmware 153 allocates, according to the resource allocation ratio, available spaces 411 and 412 (for example, of 1.5 G) to the Microsoft Windows OS, and allocates the an available space 413 (for example, of 0.5 G) to the Linux OS.

Return to FIG. 2, after the hardware resources are allocated, as shown in Step S220, each of the OSs is loaded according to the hardware resources allocated to each of the OSs. For example, a magnetic disk information management program is built in the coexistence platform firmware 15, through which divisions required by the storage unit 130 can be arranged in advance, to divide the storage unit 130 into multiple partitions, for installing multiple OSs respectively, and boot information of each of the OSs is recorded in the coexistence platform firmware 153. For example, in case that the storage unit 130 is a hard disk, the hard disk is divided into a C groove and a D groove, in which the C groove is used for installing the Microsoft Windows OS, and the D groove is used for installing the Linux OS. The coexistence platform firmware 153 loads different OSs respectively to the available space allocated thereto of the main memory 140 at the same time, so as to simultaneously and respectively execute the OSs.

For example, as shown in FIGS. 3 and 4C, in case that the Microsoft Windows OS and the Linux OS are installed in the electronic apparatus 100, after the hardware resources are allocated, the logic three-core CPU 310 and the available spaces 411 and 412 are allocated to the Microsoft Windows OS; and the logic single-core CPU 320 and the available space 413 are allocated to the Linux OS. Then, a preset BSP (i.e., the core 301) of the logic three-core CPU 310 loads a kernel of the Microsoft Windows OS from the storage unit 130 to the available spaces 411 and 412, and a virtual BSP (that is, the core 304) of the logic single-core CPU 320 loads a kernel of the Linux OS from the storage unit 130 to the available space 413.

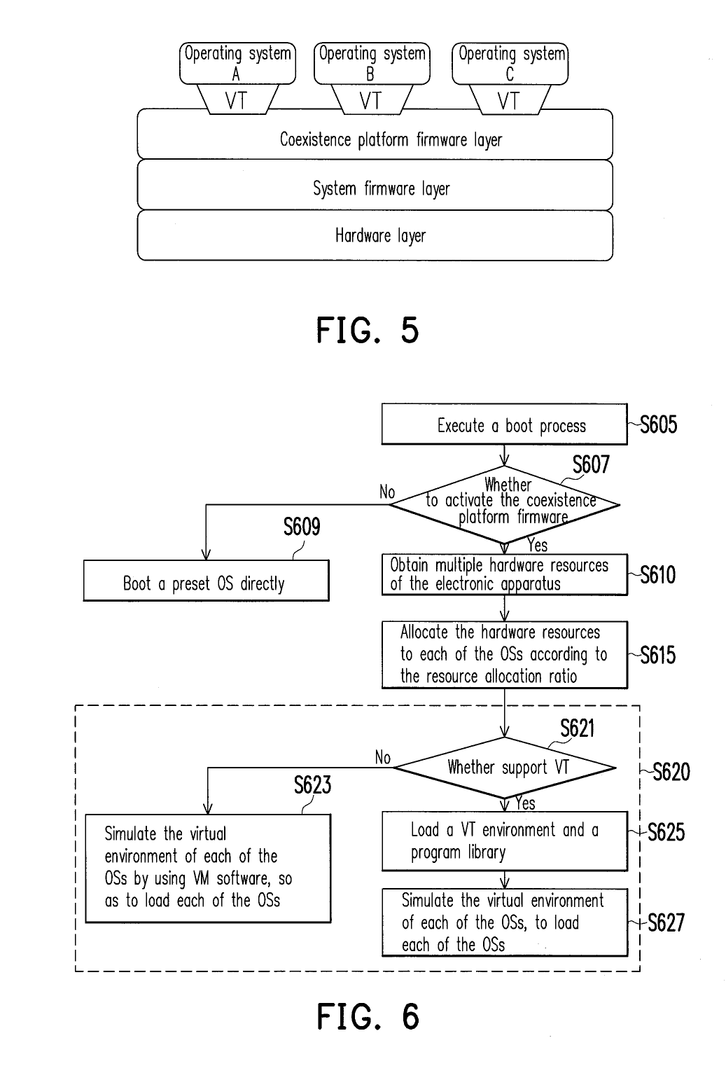

Furthermore, FIG. 5 is a schematic view of system architecture according to an embodiment of the present invention. Referring to FIG. 5, a bottom layer is a hardware layer used for providing a physical hardware interface. A system firmware layer is located above the hardware layer, and used for executing a boot process. A coexistence platform firmware layer is located above the system firmware layer, and the functions thereof are as described for the coexistence platform firmware 153. A VT layer is located above the coexistence platform firmware layer, which simulates a virtual environment of each OS by using VT technology respectively, so as to execute the OSs on the VT layer.

FIG. 6 is a flow chart of a method for executing multiple OSs according to another embodiment of the present invention. Referring to FIGS. 1 and 6, in Step S605, a boot process is executed. Then, in Step S607, it is determined whether to activate the coexistence platform firmware 153. For example, after the boot process is executed, an option is displayed on the display unit 160, for being used by a user to select whether to activate the coexistence platform firmware 153. If the coexistence platform firmware 153 is not activated, Step S609 is performed, in which a preset OS is directly booted. If the coexistence platform firmware 153 needs to be activated, Step S610 is performed, to obtain the current hardware resources of the electronic apparatus. Moreover, in Step S615, the hardware resources are allocated to each of the OSs according to the resource allocation ratio. In this embodiment, Steps S605, S610, and S615 are respectively similar to Steps S205, S210, and S215, and are not further described in detail herein again.

Then, in Step S620, each of the OSs is loaded according to the hardware resources allocated to each of the OSs. Step S620 includes Sub-steps S621, S623, S625, and S627. Each sub-step is described in detail below.

In Step S621, it is determined whether the electronic apparatus 100 supports VT, so as to determine to simulate respective virtual environment of each of the OSs by using VT or VM software. If the electronic apparatus 100 does not support VT, Step S623 is performed, to simulate the virtual environment of each of the OSs by using VM software, so as to load each of the OSs. If the electronic apparatus 100 supports VT, Step S625 is performed, to load a VT environment and a program library. And, in Step S627, the virtual environment of each of the OSs is simulated, to load each of the OSs. In this embodiment, the VM software is, for example, VMWare, which is a virtual platform suit software of a Intel x86 architecture compatible computer, and allows a user to create and execute multiple x86 virtual platforms on the basis of an original OS. VT is a technology for implementing and simulating x86 computer platform through hardware, which is different from different from VMWare, since VMWare is a technology that simulates a computer platform through software, and the performance difference therebetween is vast. Therefore, if the electronic apparatus 100 supports VT, OSs can obtain allocation of more entity resources, so as to greatly improve the execution efficiency.

To sum up, in the above embodiment, after the boot process is ended and before the OSs are loaded, the obtained hardware resources of the electronic apparatus are allocated to each of the OSs according to the resource allocation ratio, so as to load multiple OSs onto the electronic apparatus at the same time and execute multiple OSs on the electronic apparatus. Accordingly, efficient operating capability can be obtained, and a user can switch the OSs at will at any time point, so that the user can execute software supporting different OSs at the same period of time, thereby greatly improving the operating efficiency. Furthermore, the method is based on the system firmware, and then on the hardware resources after the electronic apparatus is initialized, so that the subsequent maintenance operations become simple.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for executing multiple Operating Systems (OSs), applicable to an electronic apparatus installed with multiple OSs, comprising:
executing a boot process;
obtaining multiple hardware resources of the electronic apparatus;
allocating the hardware resources to each of the OSs according to a resource allocation ratio; and
loading each of the OSs according to the hardware resources allocated to each of the OSs.

2. The method for executing multiple OSs according to claim 1, wherein the step of allocating the hardware resources to each of the OSs according to the resource allocation ratio comprises:
registering multiple cores of a Central Processing Unit (CPU) respectively to the OSs according to the resource allocation ratio;
allocating an available space of a main memory to the OSs according to the resource allocation ratio; and
loading each of the OSs to the available space allocated thereto of the main memory.

3. The method for executing multiple OSs according to claim 1, wherein before the step loading each of the OSs according to the hardware resources allocated to each of the OSs, the method further comprises:
determining whether the electronic apparatus supports a Virtualization Technology (VT), so as to determine to simulate respective virtual environment of each of the OSs by using VT or Virtual Machine (VM) software.

4. The method for executing multiple OSs according to claim 1, further comprising:
dividing a storage unit of the electronic apparatus into multiple partitions, so as to install the OSs respectively in the partitions; and
recording respective booting information of the OSs to a firmware memory.

5. The method for executing multiple OSs according to claim 1, wherein after the step of loading each of the OSs according to the hardware resources allocated to each of the OSs, the method further comprises:
selecting one of the OSs and displaying the OS on a display unit.

6. An electronic apparatus, comprising:
a storage unit, for storing multiple Operating Systems (OSs);
a main memory;
a firmware memory, for storing a system firmware and a coexistence platform firmware;
a Central Processing Unit (CPU), coupled to the storage unit, the main memory, and the firmware memory, wherein the CPU executes the system firmware to perform a boot process, and executes the coexistence platform firmware, so as to obtain multiple hardware resources of the electronic apparatus by using the coexistence platform firmware, allocate the hardware resources to each of the OSs according to a resource allocation ratio, and load each of the OSs according to the resources allocated to each of the OSs.

7. The electronic apparatus according to claim 6, wherein the CPU executes the coexistence platform firmware, and registers multiple cores of the CPU respectively to the OSs and allocates an available space of the main memory to the OSs by using the coexistence platform firmware according to the resource allocation ratio, wherein the CPU loads each of the OSs respectively to the available space allocated thereto of the main memory.

8. The electronic apparatus according to claim 6, wherein the CPU executes the coexistence platform firmware, and determines whether the electronic apparatus supports a Virtualization Technology (VT) by using the coexistence platform firmware, so as to determine to simulate respective virtual environment of each of the OSs by using VT or Virtual Machine (VM) software.

9. The electronic apparatus according to claim 6, wherein the storage unit comprises multiple partitions, the OSs are installed respectively in the partitions, and the firmware memory records respective booting information of the OSs.

10. The electronic apparatus according to claim 6, further comprising:
a display unit, coupled to the CPU, and displaying one of the OSs.
